(19) United States
(12) Patent Application Publication
(10) Pub. No.: US 2013/0162767 A1
(43) Pub. Date: Jun. 27, 2013

(54) ENDOSCOPE AND WIRELESS TRANSMISSION SYSTEM THEREOF

(71) Applicants: Yi-Chen Chou, Tainan City (TW); Yung-Che Chung, Tainan City (TW)

(72) Inventors: Yi-Chen Chou, Tainan City (TW); Yung-Che Chung, Tainan City (TW)

(73) Assignee: HIMAX IMAGING LIMITED, Tainan City (TW)

(21) Appl. No.: 13/335,730

(22) Filed: Dec. 22, 2011

(51) Int. Cl. H04N 7/18; H04N 13/00

(52) U.S. Cl. 348/43; 348/65; 348/E13.001; 348/E07.085

(57) ABSTRACT

An endoscope, tied-in a display device, including a tube, a distal section and a handling section is provided. The distal section, coupled to a distal end of the tube, includes a first wafer-level image sensor which is disposed to capture at least one first image. The handling section, coupled to a proximal end of the tube, includes a transmitter which transmits the first image to the display device via a wireless connection.

### BACKGROUND OF THE INVENTION

1. Field of the Invention

The present invention generally relates to an endoscope, and more particularly to an endoscope and a wireless transmission system thereof.

2. Description of Related Art

An endoscope is an instrument that is capable of being inserted into an organ to examine the interior of the organ. The endoscope generally includes a flexible tube and a lens system disposed at a distal end of the endoscope for collecting images of the interior of the organ. The captured images are transmitted to an external display device via a wired connection for examination by a user (e.g., a doctor). However, it is quite inconvenient that the user must operate the endoscope and observe the captured images at the same time.

Moreover, due to the miniature dimension of the endoscope, the manufacturing of the lens system requires great effort and thus making the overall cost high. As far as the cost and practicality are concerned, since the conventional endoscope is not only high-priced but also unable to observe the captured images conveniently, a need has arisen to propose a novel endoscope that eliminates the problems mentioned above.

### SUMMARY OF THE INVENTION

In view of the foregoing, the embodiment of the present invention provides an endoscope having a distal section made of a wafer-level imaging module, transmitting an image by wireless. The endoscope of the embodiment may not only reduce the overall cost of the endoscope, but also facilitate operating the endoscope.

According to one embodiment, an endoscope, tied-in a display device, including a tube, a distal section and a handling section is provided. The distal section, coupled to a distal end of the tube, includes a first wafer-level image sensor which is disposed to capture at least one first image. The handling section, coupled to a proximal end of the tube, includes a transmitter which transmits the first image to the display device via a wireless connection.

According to another embodiment, a wireless transmission system including an endoscope and a display device is provided. The endoscope includes a tube, a distal section and a handling section. The distal section, coupled to a distal end of the tube, includes a first wafer-level image sensor which is disposed to capture at least one first image. The handling section, coupled to a proximal end of the tube, includes a transmitter which transmits the first image to the display device via a wireless connection. The display device includes a receiver which receives the first image via the wireless connection and at least one eyeglass which displays the first image.

### BRIEF DESCRIPTION OF THE DRAWINGS

FIG. 1 schematically shows an architecture diagram of a wireless transmission system according to one embodiment of the present invention;

FIG. 2 schematically shows a perspective view of the distal section of FIG. 1 according to one embodiment of the present invention;

FIG. 3 schematically shows a block diagram of a wireless transmission system of FIG. 1 according to one embodiment of the present invention; and

FIG. 4 schematically shows a perspective view of the distal section of FIG. 1 according to another embodiment of the present invention.

### DETAILED DESCRIPTION OF THE INVENTION

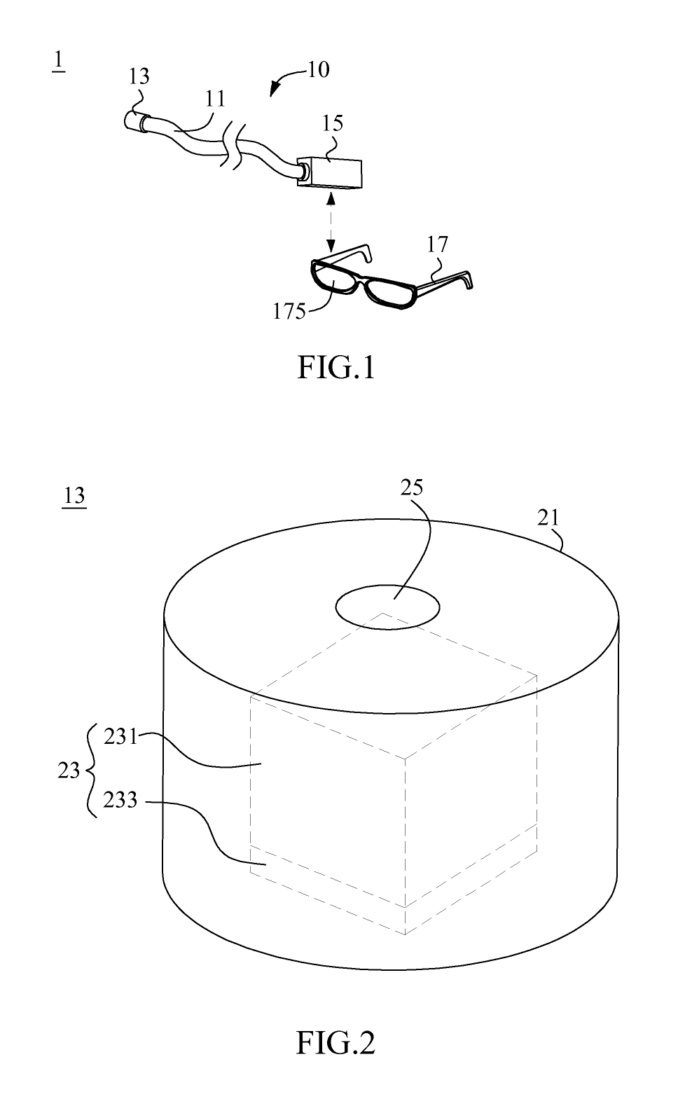

FIG. 1 schematically shows an architecture diagram of a wireless transmission system 1 according to one embodiment of the present invention. As shown in FIG. 1, the wireless transmission system 1 includes an endoscope 10 and a display device 17. The endoscope 10 includes a tube 11, a distal section 13 and a handling section 15. Specifically, the distal section 13 is disposed at and coupled to a distal end of the tube 11, and the handling section 15 is disposed at and coupled to a proximal end of the tube 11.

FIG. 2 schematically shows a perspective view of the distal section 13 according to one embodiment of the present invention. As shown in FIG. 2, the distal section 13 of the embodiment primarily includes a wafer-level imaging module 23 (or wafer-level module, WLM, for short) containing a wafer-level image sensor 233 and a wafer-level optics 231. The wafer-level image sensor 233 is situated facing the distal end of the tube 11, and may be, but not limited to, a complementary metal oxide semiconductor (CMOS) image sensor (commonly abbreviated as CIS). The wafer-level optics 231, such as a lens, is situated away from the distal end of the tube 11, and may be made of, but not limited to, glass. The wafer-level image sensor 233 and the wafer-level optics 231 may be bonded together, for example, with an adhesive. Compared to the conventional endoscope, the endoscope of the present embodiment makes use of the mass-productivity and low cost of semiconductor technique to manufacture the imaging system of the endoscope. Wafer-level module is a technique of fabricating miniaturized optics such as lens module or camera module at the wafer level using semiconductor techniques, and details of manufacturing the wafer-level imaging module 12 may be referred, for example, to U.S. Pat. No. 7,564,496 to Wolterink et al., entitled “Camera device, method of manufacturing a camera device, wafer scale package,” the disclosure of which is incorporated herein by reference.

The distal section 13 further includes a holder 21 for housing the wafer-level module 23, containing the wafer-level image sensor 233 and the wafer-level optics 231. In one embodiment, the holder 21 has an opening 25 situated above and aligned with the wafer-level modules 23. So that the wafer-level image sensor 233 may capture at least one image via the opening 25.

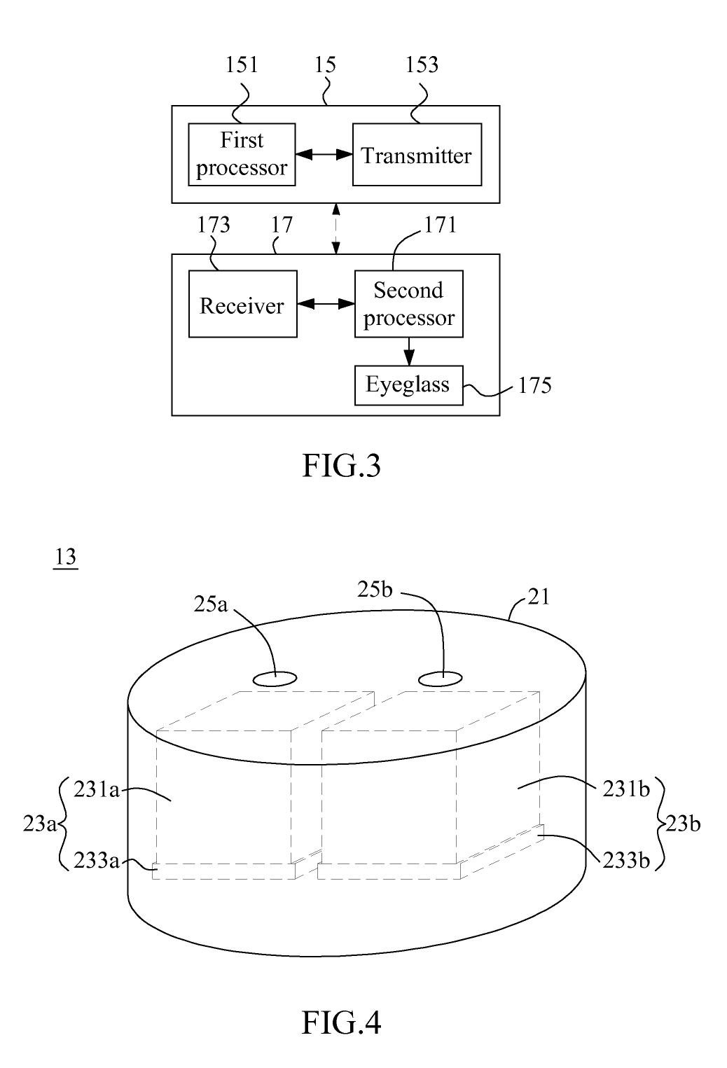

In order to facilitate operation, the images captured by the wafer-level image sensor 233 of the embodiment are directly transmitted to an eyeglass 175 of the display device 17 to be displayed. FIG. 3 schematically shows a block diagram of a wireless transmission system of FIG. 1 according to one embodiment of the present invention. As shown in FIG. 3, the handling section 15 includes a first processor 151 and a transmitter 153. The first processor 151 is disposed to control the operations of the endoscope 10, for example, it controls the wafer-level image sensor 233 to capture an image. The transmitter 153 may transmit the captured image to the display device 17 via a wireless connection.

Specifically, the display device 17 may be, but not limited to, a head-mounted display. The display device 17 includes a second processor 171, a receiver 173 and an eyeglass 175 (e.g., a right eyeglass). The receiver 173 receives the images from the transmitter 153 via the wireless connection. The second processor 171 is disposed to control the operations of the display device 17, for example, it controls the receiver 173 to receive an image and convert the received image into an image in adaptive format, so as to directly display it on the eyeglass 175. In one embodiment, the image may be displayed on a single eyeglass 175 (left eyeglass or right eyeglass) or both eyeglasses 175 of the head-mounted display.

Finally, FIG. 4 schematically shows a perspective view of the distal section of FIG. 1 according to another embodiment of the present invention. The distal section 13 may also include a left and a right wafer-level modules 23a, 23b, containing a left wafer-level image sensor 231a, a left wafer-level optics 233a, and a right wafer-level image sensor 231b, a right, wafer-level optics 233b, respectively. The left wafer-level module 23a is aligned with the right wafer-level module 23b in the holder 21. The left wafer-level image sensor 231a may capture at least one left image via the openings 25a, and the right wafer-level image sensor 231b may capture at least one right image via the openings 25b. So that the first processor 151 processes the captured left and right images as a 3D image, and the 3D image is transmitted by the transmitter 153 to the eyeglass 175 of the head-mounted display for displaying. Specifically, the left image of the 3D image is displayed on the left eyeglass 175, and the right image of the 3D image is displayed on the right eyeglass 175. In addition, besides cubic shape, the holder 21 can be into the shape of a cylinder preferably to fit in with the tube 11.

According to the above embodiment, the endoscope, provided in the present invention, integrates the wafer-level module and the wireless transmission system, so as to facilitate operation and transmit the captured image wirelessly for observation or examination.

Although specific embodiments have been illustrated and described, it will be appreciated by those skilled in the art that various modifications may be made without departing from the scope of the present invention, which is intended to be limited solely by the appended claims.

What is claimed is:

1. An endoscope for tying-in a display device, comprising:
a tube; and
a distal section coupled to a distal end of the tube, comprising:
a first wafer-level image sensor disposed to capture at least one first image; and
a handling section coupled to a proximal end of the tube, comprising:
a transmitter disposed to transmit the first image to the display device via a wireless connection.

2. The endoscope of claim 1, wherein the display device comprises a head-mounted display, comprising:
a receiver disposed to receive the first image via the wireless connection; and
at least one eyeglass disposed to display the first image.

3. The endoscope of claim 2, wherein the distal section further comprises:
a first wafer-level optics bonded with the first wafer-level image sensor;
wherein, the first wafer-level image sensor is situated facing the distal end of the tube, and the first wafer-level optics is situated away from the distal end of the tube.

4. The endoscope of claim 3, further comprising:
a holder disposed to house the distal section.

5. The endoscope of claim 4, wherein the handling section further comprises:
a first processor disposed to control the operations of the endoscope.

6. The endoscope of claim 5, wherein the display device further comprises:
a second processor disposed to control the operations of the display device and convert the first image into an image in adaptive format.

7. The endoscope of claim 6, wherein the distal section further comprises:
a second wafer-level image sensor disposed to capture at least one second image; and
a second wafer-level optics bonded with the second wafer-level image sensor;
wherein, the second wafer-level image sensor is situated facing the distal end of the tube, and the second wafer-level optics is situated away from the distal end of the tube.

8. The endoscope of claim 7, wherein the first processor processes the first and second images as a 3D image, and the 3D image is transmitted by the transmitter to the eyeglass for displaying.

9. The endoscope of claim 7, wherein the first and second wafer-level image sensors comprise a complementary metal oxide semiconductor (CMOS) image sensor.

10. The endoscope of claim 7, wherein, the first and second wafer-level optics comprise a lens.

11. The endoscope of claim 10, wherein the lens is made of glass.

12. The endoscope of claim 7, wherein the holder has at least one opening situated above the first and second wafer-level optics.

13. The endoscope of claim 4, wherein the holder is into the shape of a cubic shape or a cylinder.

14. A wireless transmission system, comprising:
an endoscope, comprising:
a tube;
a distal section coupled to a distal end of the tube, comprising:
a first wafer-level image sensor disposed to capture at least one first image; and
a handling section couple. to a proximal end of the tube, comprising:
a transmitter disposed to transmit the first image via a wireless connection; and
a display device, comprising;
a receiver disposed to receive the first image via the wireless connection; and
at least one eyeglass disposed to display the first image.

15. The wireless transmission system of claim 14, wherein the display device comprises a head-mounted display.

16. The wireless transmission system of claim 14, wherein the distal section further comprises:
a first wafer-level optics bonded with the first wafer-level image sensor;
wherein, the first wafer-level image sensor is situated facing the distal end of the tube, and the first wafer-level optics is situated away from the distal end of the tube.

17. The wireless transmission system of claim 16, wherein the handling section further comprises:
a first processor disposed to control the operations of the endoscope.

18. The wireless transmission system of claim 17, wherein the display device further comprises:
a second processor disposed to control the operations of the display device and convert the first image into an image in adaptive format.

19. The wireless transmission system of claim 18, wherein the distal section further comprises:
a second wafer-level image sensor disposed to capture at least one second image; and
a second wafer-level optics bonded with the second wafer-level image sensor;
wherein, the second wafer-level image sensor is situated facing the distal end of the tube, and the second wafer-level optics is situated away from the distal end of the tube.

20. The wireless transmission system of claim 19, wherein the first processor processes the first and second images as a 3D image, and the 3D image is transmitted by the transmitter to the eyeglass for displaying.
